(19) United States
(12) Patent Application Publication
(10) Pub. No.: US 2017/0327107 A1
(43) Pub. Date: Nov. 16, 2017

(54) HYBRID AUTOMOBILE

(71) Applicants: TOYOTA JIDOSHA KABUSHIKI KAISHA, Toyota-shi, Aichi-ken (JP); DENSO CORPORATION, Kariya-city, Aichi-Pref (JP)

(72) Inventors: Takashi ANDO, Nissin-shi (JP); Wataru NAGASHIMA, Kariya-shi (JP)

(73) Assignees: TOYOTA JIDOSHA KABUSHIKI KAISHA, Toyota-shi, Aichi-ken (JP); DENSO CORPORATION, Kariya-city, Aichi-pref (JP)

(21) Appl. No.: 15/531,327

(22) PCT Filed: Dec. 3, 2015
(86) PCT No.: PCT/IB2015/002278

§ 371 Date: May 26, 2017

(30) Foreign Application Priority Data
Dec. 5, 2014 (JP) 2014-246968

(51) Int. Cl. B60W 20/50; B60K 6/365; B60W 10/08; B60K 6/46; B60W 10/06

(52) U.S. Cl. CPC B60W 20/50; B60K 6/46; B60W 10/06; B60W 10/08; B60K 6/365; B60W 2710/0666; B60W 2710/0627; B60W 2710/0605; B60W 2540/16; B60W 2540/12; B60W 2540/10; B60W 2520/10; B60W 2510/244; B60W 2510/085; B60W 2510/081; B60W 2510/0685; B60W 2510/0657; B60W 2510/0628; B60W 2710/0677; B60W 2710/081; B60W 2710/083; Y10S 903/93; Y10S 903/91

(57) ABSTRACT

In a hybrid automobile in which a first motor, an engine, and a drive shaft coupled to an axle are connected respectively to a sun gear, a carrier, and a ring gear of a planetary gear set and a second motor is connected to the drive shaft, during a predetermined travel period in which the engine is operative and respective gates of a first inverter and a second inverter used to drive the first motor and the second motor are both blocked, the engine is controlled such that the first motor rotates at a predetermined rotation speed, and a boost converter is controlled such that a voltage of a drive voltage system power line reaches a target voltage corresponding to an accelerator depression amount.

### BACKGROUND OF THE INVENTION

### 1. Field of the Invention

The invention relates to a hybrid automobile, and more particularly to a hybrid automobile having an engine, a first motor that receives and outputs power, a planetary gear set connected to a rotational shaft of the first motor, an output shaft of the engine, and a drive shaft coupled to an axle such that when respective rotation speeds of these three rotational elements, i.e. the rotational shaft, the output shaft, and the drive shaft, are shown on a collinear diagram, the rotational shaft, the output shaft, and the drive shaft are arranged in that order, a second motor that receives and outputs power from and to the drive shaft, a first inverter for driving the first motor, a second inverter for driving the second motor, a battery, and a boost converter connected to a drive voltage system power line to which the first motor and the second motor are connected and a battery voltage system power line to which the battery is connected.

### 2. Description of Related Art

A hybrid vehicle having an engine, a first motor, a power split-integration mechanism (a planetary gear set mechanism) configured such that a sun gear, a carrier, and a ring gear are connected respectively to a rotational shaft of the first motor, a crankshaft of the engine, and an output member coupled to an axle, a second motor having a rotational shaft that is connected to a drive shaft, a first inverter and a second inverter for driving the first motor and the second motor, and a battery that exchanges power with the first motor and the second motor via the first inverter and the second inverter has been proposed in the related art (see Japanese Patent Application Publication No. 2013-203116 (JP 2013-203116 A), for example). In this hybrid automobile, when a fault occurs in the first inverter and the second inverter while the engine is operative, respective gates of the first inverter and the second inverter are blocked, whereupon a rotation speed of the engine is controlled in accordance with a direct current side voltage of the inverter, a rotation speed of the output member, and a condition of an accelerator. In so doing, braking torque derived from a counter-electromotive voltage generated as the first motor rotates is adjusted, with the result that reaction torque (drive torque generated by the output member) to the braking torque is adjusted.

In the hybrid automobile described above, during travel in a condition where the engine is operative and the gates of the first inverter and the second inverter are blocked, a driving force generated by the output member is adjusted simply by controlling the rotation speed of the engine. It may therefore be impossible to adjust the driving force generated by the output member sufficiently to a value corresponding to the condition of the accelerator. Hence, room for improvement remains in terms of the controllability of the vehicle.

### SUMMARY OF THE INVENTION

In consideration of the problem described above, the invention provides a hybrid automobile in which controllability can be improved during travel in a condition where an engine is operative and respective gates of a first inverter and a second inverter used to drive a first motor and a second motor are blocked.

According to an aspect of the invention, a hybrid automobile having an engine, a first motor, a planetary gear set, a second motor, a first inverter, a second inverter, a battery, a boost converter, and a controller is provided. The first motor is configured to receive and output power. The planetary gear set is connected to a rotational shaft of the first motor, an output shaft of the engine, and a drive shaft coupled to an axle such that when respective rotation speeds of the rotational shaft, the output shaft, and the drive shaft, are shown on a collinear diagram, the rotational shaft, the output shaft, and the drive shaft are arranged in that order. The second motor is configured to receive and output power from and to the drive shaft. The first inverter is configured to drive the first motor. The second inverter is configured to drive the second motor. The boost converter is connected to a drive voltage system power line to which the first motor and the second motor are connected and a battery voltage system power line to which the battery is connected. The boost converter is configured to adjust a voltage of the drive voltage system power line within a range equaling or exceeding a voltage of the battery voltage system power line. The controller is configured to (i) control the engine and the boost converter, during a predetermined travel period in which the engine is operative and respective gates of the first inverter and the second inverter are blocked, such that travel is performed using a counter-electromotive torque generated when the first motor rotates at a rotation speed corresponding to the rotation speed of the drive shaft and a rotation speed of the engine, and (ii) control the engine such that the first motor rotates at a predetermined rotation speed and control the boost converter such that the voltage of the drive voltage system power line reaches a target voltage corresponding to an accelerator operation amount during the predetermined travel period.

In the hybrid automobile according to the invention, during the predetermined travel period in which the engine is operative and the respective gates of the first inverter and the second inverter are blocked, the engine and the boost converter are controlled such that travel is performed using the counter-electromotive torque generated when the first motor rotates at a rotation speed corresponding to the rotation speed of the drive shaft and the rotation speed of the engine. More specifically, during the predetermined travel period, the engine is controlled such that the first motor rotates at the predetermined rotation speed, and the boost converter is controlled such that the voltage of the drive voltage system power line reaches the target voltage corresponding to the accelerator operation amount. The counter-electromotive torque varies in accordance with the rotation speed of the first motor and the voltage of the drive voltage system power line. Therefore, by controlling the engine and the boost converter in this manner, the counter-electromotive torque can be adjusted more appropriately than when the engine is controlled alone. As a result, an improvement in controllability can be achieved during travel performed while the respective gates of the first inverter and the second inverter are blocked.

In the hybrid automobile according to the invention, the predetermined rotation speed may be a rotation speed within a rotation speed range in which an absolute value of the counter-electromotive torque increases steadily as the voltage of the drive voltage system power line decreases. Further, the controller may be configured to set the target voltage of the drive voltage system power line to decrease steadily as the accelerator operation amount increases during the predetermined travel period.

Furthermore, in the hybrid automobile according to the invention, the predetermined rotation speed may be a rotation speed at which the absolute value of the counter-electromotive torque reaches a maximum when the gate of the first inverter is blocked and the voltage of the drive voltage system power line is equal to the voltage of the battery voltage system power line.

Furthermore, in the hybrid automobile according to the invention, the predetermined rotation speed may be a rotation speed within a first rotation speed range in which an absolute value of the counter-electromotive torque decreases steadily as the voltage of the drive voltage system power line increases. The predetermined rotation speed may also be a rotation speed within a second rotation speed range in which an absolute value of the counter-electromotive torque increases steadily as the voltage of the drive voltage system power line increases. When, at this time, a rotation speed within the second rotation speed range is used as the predetermined rotation speed, the controller may be configured to set the target voltage of the drive voltage system power line so as to increase steadily as the accelerator operation amount increases.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a configuration of a hybrid automobile serving as an embodiment of the invention;

FIG. 2 is a schematic view showing a configuration of an electric driving system including a first motor and a second motor shown in FIG. 1, according to this embodiment;

FIG. 3 is a flowchart showing an example of a predetermined travel period control routine executed by a hybrid electronic control unit (HV ECU) shown in FIG. 1, according to this embodiment;

FIG. 4 is an illustrative view illustrating an example of a collinear diagram showing a relationship between rotation speeds of respective rotational elements of a planetary gear set shown in FIG. 1 during a predetermined travel period, according to this embodiment;

FIG. 5 is an illustrative view illustrating an example of a relationship between a rotation speed of the first motor, a voltage of a drive voltage system power line, and a counter-electromotive torque of the first motor when a gate of a first inverter shown in FIG. 1 is blocked, according to this embodiment;

FIG. 6 is an illustrative view illustrating an example of a target voltage setting map according to this embodiment; and

FIG. 7 is an illustrative view illustrating an example of the relationship between the rotation speed of the first motor, the voltage of the drive voltage system power line, and the counter-electromotive torque of the first motor when the gate of the first inverter shown in FIG. 1 is blocked, according to a modified example of this embodiment.

### DETAILED DESCRIPTION OF EMBODIMENTS

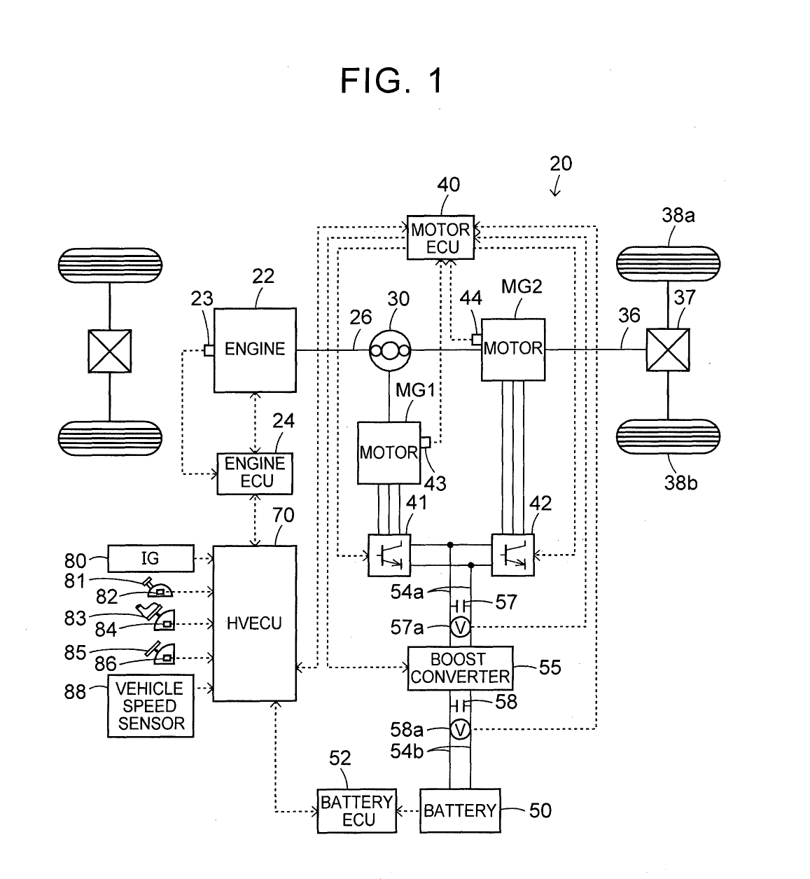

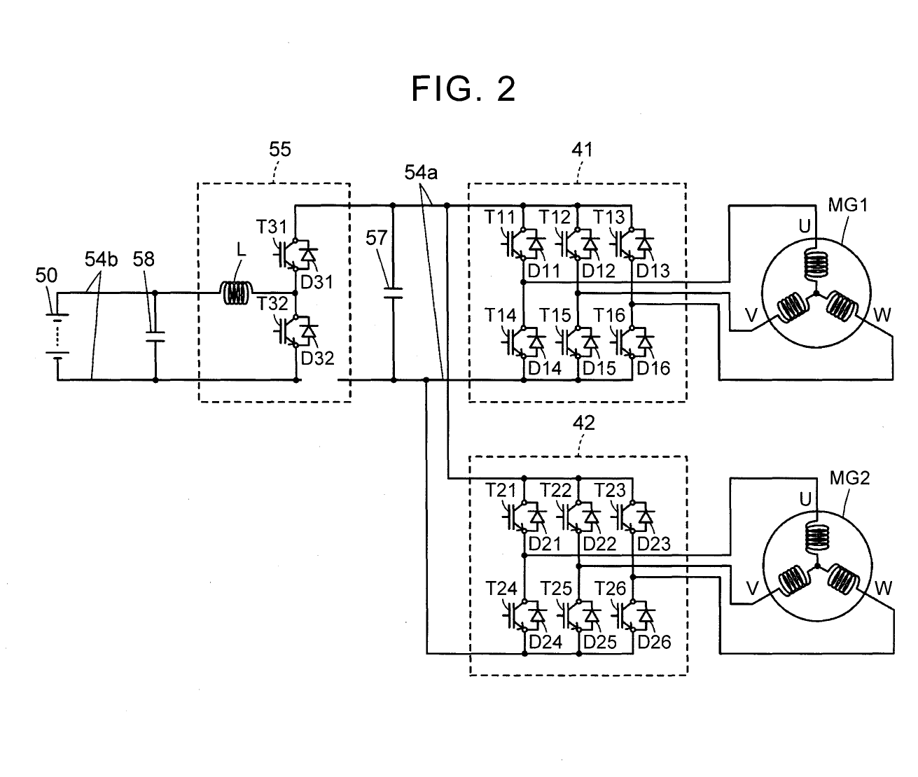

Next, an embodiment of the invention will be described. FIG. 1 is a schematic view showing a configuration of a hybrid automobile 20 serving as an embodiment of the invention, and FIG. 2 is a schematic view showing a configuration of an electric driving system including a first motor MG1 and a second motor MG2. As shown in FIG. 1, the hybrid automobile 20 according to this embodiment includes an engine 22, a planetary gear set 30, the first motor MG1, the second motor MG2, a first inverter 41, a second inverter 42, a boost converter 55, a battery 50, and an HV ECU 70.

The engine 22 is configured as an internal combustion engine that outputs power using gasoline, light oil, or the like as fuel. Operations of the engine 22 are controlled by an engine electronic control unit (referred to hereafter as an engine ECU) 24.

The engine ECU 24, although not shown in the drawing, is configured as a microprocessor centering on a central processing unit (CPU) and including, in addition to the CPU, a read only memory (ROM) that stores a processing program, a random access memory (RAM) that stores data temporarily, input/output ports, and a communication port. Signals from various sensors required to control operations of the engine 22, for example a crank angle θcr from a crank position sensor 23 that detects a rotation position of a crankshaft 26 and so on, are input into the engine ECU 24 via the input port. Further, various control signals for controlling operations of the engine 22, for example a drive signal for a throttle motor that adjusts a position of a throttle valve, a drive signal for a fuel injection valve, a control signal for an ignition coil integrated with an igniter, and so on, are output from the engine ECU 24 via the output port. The engine ECU 24 is connected to the HV ECU 70 via the communication port in order to control operations of the engine 22 in response to control signals from the HV ECU 70 and output data relating to operating conditions of the engine 22 to the HV ECU 70 as required. Note that the engine ECU 24 calculates a rotation speed of the crankshaft 26, or in other words a rotation speed Ne of the engine 22, on the basis of the crank angle θcr detected by the crank position sensor 23.

The planetary gear set 30 is configured as a single pinion type planetary gear set mechanism. A rotor of the first motor MG1 is connected to a sun gear of the planetary gear set 30. A drive shaft 36 coupled to drive wheels 38a, 38b via a differential gear 37 is connected to a ring gear of the planetary gear set 30. The crankshaft 26 of the engine 22 is connected to a carrier of the planetary gear set 30.

The first motor MG1 is configured as a synchronous motor/generator having a rotor in which a permanent magnet is embedded and a stator around which a three-phase coil is wound. As described above, the rotor is connected to the sun gear of the planetary gear set 30. The second motor MG2, similarly to the first motor MG1, is configured as a synchronous motor/generator, and a rotor thereof is connected to the drive shaft 36.

As shown in FIGS. 1 and 2, the first inverter 41 is connected to a drive voltage system power line 54a. The first inverter 41 includes six transistors T11 to T16, and six diodes D11 to D16 connected in parallel to the transistors T11 to T16 in an opposite direction to the transistors T11 to T16. The transistors T11 to T16 are disposed in pairs respectively constituted by a source side transistor and a sink side transistor relative to a positive electrode bus line and a negative electrode bus line of the drive voltage system power line 54a. Further, coils (a U phase coil, a V phase coil, and a W phase coil) forming the three-phase coil of the first motor MG1 are connected to respective connecting points between the transistor pairs formed by the transistors T11 to T16. Hence, by having a motor electronic control unit (referred to hereafter as a motor ECU) 40 adjust ON time proportions of the pairs of transistors T11 to T16 while a voltage is applied to the first inverter 41, a rotating magnetic field is formed in the three-phase coil, and as a result, the first motor MG1 is driven to rotate. In the invention, the HV ECU 70, the engine ECU 24, and the motor ECU 40 are handled collectively as an example of a controller.

The second inverter 42, similarly to the first inverter 41, includes six transistors T21 to T26 and six diodes D21 to D26. By having the motor ECU 40 adjust the ON time proportions of the pairs of transistors T21 to T26 while a voltage is applied to the second inverter 42, a rotating magnetic field is formed in the three-phase coil, and as a result, the second motor MG2 is driven to rotate.

The boost converter 55 is connected to the drive voltage system power line 54a, to which the first inverter 41 and the second inverter 42 are connected, and a battery voltage system power line 54b, to which the battery 50 is connected, in order to adjust a voltage of the drive voltage system power line 54a within a range no lower than a voltage VL of the battery voltage system power line 54b and no higher than an allowable upper limit voltage VHmax. The boost converter 55 includes two transistors T31, T32, two diodes D31, D32 connected in parallel to the transistors T31, T32 in an opposite direction to the transistors T31, T32, and a reactor L. The transistor T31 is connected to the positive electrode bus line of the drive voltage system power line 54a. The transistor T32 is connected to the transistor T31 and respective negative electrode bus lines of the drive voltage system power line 54a and the battery voltage system power line 54b. The reactor L is connected to a connection point between the transistors T31, T32 and a positive electrode bus line of the battery voltage system power line 54b. By having the motor ECU 40 adjust the ON time proportions of the transistors T31, T32, the boost converter 55 boosts power on the battery voltage system power line 54b and supplies the boosted power to the drive voltage system power line 54a, and steps down power on the drive voltage system power line 54a and supplies the stepped-down power to the battery voltage system power line 54b. A smoothing capacitor 57 is attached to a positive electrode side line and a negative electrode side line of the drive voltage system power line 54a, and a smoothing capacitor 58 is attached to a positive electrode side line and a negative electrode side line of the battery voltage system power line 54b.

The motor ECU 40, although not shown in the drawings, is constituted by a microprocessor centering on a CPU and including, in addition to the CPU, a ROM that stores a processing program, a RAM that stores data temporarily, input/output ports, and a communication port. As shown in FIG. 1, signals from various sensors required to drive-control the first motor MG1, the second motor MG2, and the boost converter 55, for example rotation positions θm1, θm2 from rotation position detection sensors 43, 44 that detect respective rotation positions of the rotors of the first motor MG1 and the second motor MG2, phase currents from a current sensor that detects currents flowing through the respective phases of the first motor MG1 and the second motor MG2, a voltage VH of the capacitor 57 (the drive voltage system power line 54a) from a voltage sensor 57a attached between terminals of the capacitor 57, the voltage VL of the capacitor 58 (the battery voltage system power line 54b) from a voltage sensor 58a attached between terminals of the capacitor 58, and so on are input into the motor ECU 40 via the input port. Further, switching control signals for switching the transistors T11 to T16, T21 to T26 of the first inverter 41 and the second inverter 42, switching control signals for switching the transistors T31, T32 of the boost converter 55, and so on are output from the motor ECU 40 via the output port. The motor ECU 40 is connected to the HV ECU 70 via the communication port in order to drive-control the first motor MG1, the second motor MG2, and the boost converter 55 in response to control signals from the HV ECU 70 and output data relating to driving conditions of the first motor MG1, the second motor MG2, and the boost converter 55 to the HV ECU 70 as required. Note that the motor ECU 40 calculates rotation speeds Nm1, Nm2 of the first motor MG1 and the second motor MG2 on the basis of the rotation positions θm1, θm2 of the rotors of the first motor MG1 and the second motor MG2 from the rotation position detection sensors 43, 44.

The battery 50 is configured as a lithium ion secondary battery or a nickel hydrogen secondary battery, for example, and as described above, is connected to the battery voltage system power line 54b. The battery 50 is managed by a battery electronic control unit (referred to hereafter as a battery ECU) 52.

The battery ECU 52, although not shown in the drawings, is configured as a microprocessor centering on a CPU and including, in addition to the CPU, a ROM that stores a processing program, a RAM that stores data temporarily, input/output ports, and a communication port. Signals required to manage the battery 50, for example a battery voltage VB from a voltage sensor disposed between terminals of the battery 50, a battery current IB from a current sensor attached to an output terminal of the battery 50, a battery temperature TB from a temperature sensor attached to the battery 50, and so on, are input into the battery ECU 52 via the input port. Further, the battery ECU 52 is connected to the HV ECU 70 via the communication port in order to output data relating to conditions of the battery 50 to the HV ECU 70 as required. The battery ECU 52 manages the battery 50 by calculating a state of charge SOC, which is a ratio of an amount of power that can be discharged from the battery 50 at a certain time relative to an overall capacity thereof, on the basis of an integrated value of the battery current IB detected by the current sensor, and calculating input/output limits Win, Wout, which are maximum allowable amounts of power that can be charged to/discharged from the battery 50, on the basis of the calculated state of charge SOC and the battery temperature TB detected by the temperature sensor.

The HV ECU 70, although not shown in the drawings, is configured as a microprocessor centering on a CPU and including, in addition to the CPU, a ROM that stores a processing program, a RAM that stores data temporarily, input/output ports, and a communication port. An ignition signal from an ignition switch 80, a shift position SP from a shift position sensor 82 that detects an operation position of a shift lever 81, an accelerator depression amount Acc from an accelerator pedal position sensor 84 that detects a depression amount of an accelerator pedal 83, a brake pedal position BP from a brake pedal position sensor 86 that detects a depression amount of a brake pedal 85, a vehicle speed V from a vehicle speed sensor 88, and so on are input into the HV ECU 70 via the input port. As described above, the HV ECU 70 is connected to the engine ECU 24, the motor ECU 40, and the battery ECU 52 via the communication port in order to exchange various control signals and data with the engine ECU 24, the motor ECU 40, and the battery ECU 52.

The hybrid automobile 20 according to this embodiment, configured as described above, travels in a hybrid travel mode (an HV travel mode) in which the engine 22 is operated, and an electric travel mode (an EV travel mode) in which the engine 22 is stopped.

During travel in the HV travel mode, the HV ECU 70 first sets a required torque Tr* required for travel (i.e. to be output to the drive shaft 36) on the basis of the accelerator depression amount Acc from the accelerator pedal position sensor 84 and the vehicle speed V from the vehicle speed sensor 88. Next, the HV ECU 70 calculates a travel power Pdrv* required for travel by multiplying a rotation speed Nr of the drive shaft 36 by the set required torque Tr*. Here, a rotation speed obtained by multiplying the rotation speed Nm2 of the second motor MG2 and the vehicle speed V by a conversion factor may be used as the rotation speed Nr of the drive shaft 36. The HV ECU 70 then sets a required power Pe* required by the vehicle (i.e. to be output from the engine 22) by subtracting a charge/discharge required power Pb* of the battery 50 (which takes a positive value during discharge from the battery 50) from the calculated travel power Pdrv*. Next, the HV ECU 70 sets a target rotation speed Ne* and a target torque Te* of the engine 22 and torque commands Tm1*, Tm2* for the first motor MG1 and the second motor MG2 so that the required power Pe* is output from the engine 22 and the required torque Tr* is output from the drive shaft 36 within the range of the input/output limits Win, Wout of the battery 50. Next, the HV ECU 70 sets a target voltage VH* of the drive voltage system power line 54a on an incline so as to increase steadily as absolute values of the torque commands Tm1*, Tm2* of the first motor MG1 and the second motor MG2 and absolute values of the rotation speeds Nm1, Nm2 increase. The HV ECU 70 then transmits the target rotation speed Ne* and the target torque Te* of the engine 22 to the engine ECU 24, and transmits the torque commands Tm1*, Tm2* of the first motor MG1 and the second motor MG2 and the target voltage VH* of the drive voltage system power line 54a to the motor ECU 40. The engine ECU 24, having received the target rotation speed Ne* and the target torque Te* of the engine 22, performs intake air amount control, fuel injection control, ignition control, and the like on the engine 22 so that the engine 22 is operated on the basis of the target rotation speed Ne* and the target torque Te*. Further, the motor ECU 40, having received the torque commands Tm1*, Tm2* of the first motor MG1 and the second motor MG2 and the target voltage VH* of the drive voltage system power line 54a, performs switching control on the transistors T11 to T16, T21 to T26 of the first inverter 41 and the second inverter 42 so that the first motor MG1 and the second motor MG2 are driven in accordance with the torque commands Tm1*, Tm2*, and performs switching control on the transistors T31, T32 of the boost converter 55 so that the voltage VH of the capacitor 57 (the drive voltage system power line 54a) reaches the target voltage VH*. When a condition for stopping the engine 22 is established during travel in the HV travel mode, for example when the required power Pe* falls to or below a stoppage threshold Pstop, the engine 22 is stopped and the travel mode is switched to the EV travel mode.

During travel in the EV travel mode, the HV ECU 70 first sets the required torque Tr* on the basis of the accelerator depression amount Acc from the accelerator pedal position sensor 84 and the vehicle speed V from the vehicle speed sensor 88. Next, the HV ECU 70 sets the torque command Tm1* of the first motor MG1 at a value of zero, and sets the torque command Tm2* of the second motor MG2 so that the required torque Tr* is output to the drive shaft 36 within the range of the input/output limits Win, Wout of the battery 50. Next, the HV ECU 70 sets the target voltage VH* of the drive voltage system power line 54a on the basis of the absolute values of the torque commands Tm1*, Tm2* of the first motor MG1 and the second motor MG2 and the absolute values of the rotation speeds Nm1, Nm2. The HV ECU 70 then transmits the torque commands Tm1*, Tm2* of the first motor MG1 and the second motor MG2 and the target voltage VH* of the drive voltage system power line 54a to the motor ECU 40. The motor ECU 40, having received the torque commands Tm1*, Tm2* of the first motor MG1 and the second motor MG2 and the target voltage VH* of the drive voltage system power line 54a, performs switching control on the transistors T11 to T16, T21 to T26 of the first inverter 41 and the second inverter 42 so that the first motor MG1 and the second motor MG2 are driven in accordance with the torque commands Tm1*, Tm2*, and performs switching control on the transistors T31, T32 of the boost converter 55 so that the voltage VH of the capacitor 57 (the drive voltage system power line 54a) reaches the target voltage VH*. When a condition for starting the engine 22 is established during travel in the EV travel mode, for example when the required power Pe*, which is calculated similarly in both the EV travel mode and the HV travel mode, increases beyond the stoppage threshold P stop, the engine 22 is started and the travel mode is switched to the HV travel mode.

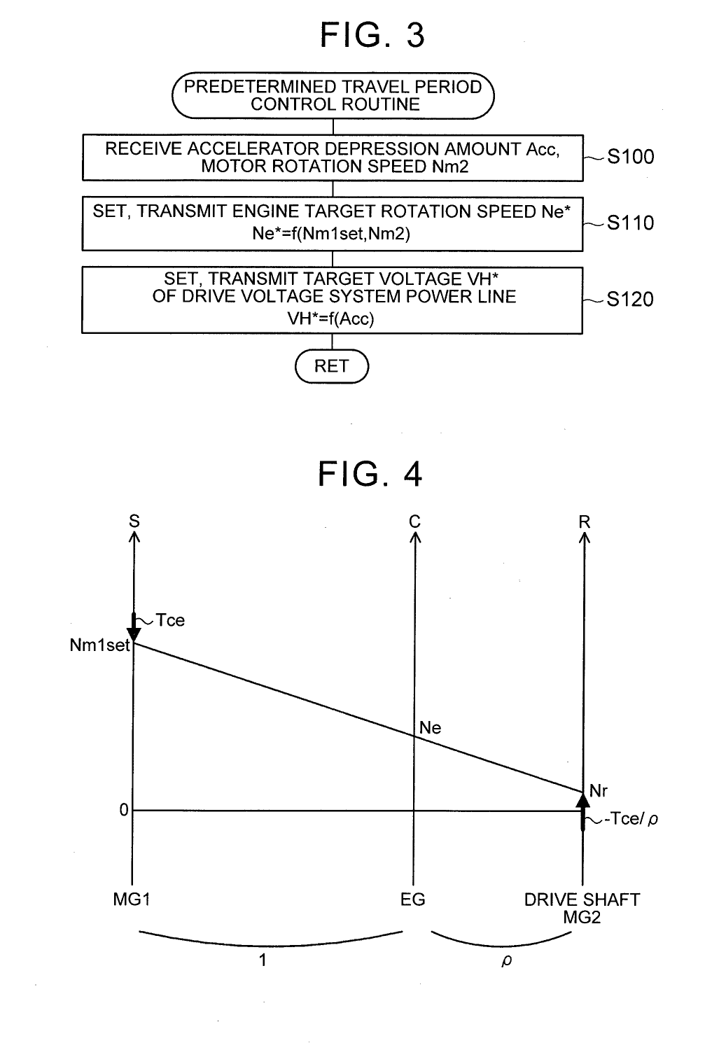

Next, an operation of the hybrid automobile 20 according to this embodiment, configured as described above, and in particular an operation performed during a predetermined travel period in which the engine 22 is operative and respective gates of the first inverter 41 and the second inverter 42 are both blocked, will be described. FIG. 3 is a flowchart showing an example of a predetermined travel period control routine executed by the HV ECU 70 according to this embodiment. This routine is executed repeatedly at predetermined time intervals during the predetermined travel period. Note that in this embodiment, when an abnormality occurs in the first inverter 41 and the second inverter 42, a supply of power from a low voltage battery, not shown in the drawings, to the motor ECU 40 is interrupted, or the like while the engine 22 is operative, the respective gates of the first inverter 41 and the second inverter 42 are both blocked, whereupon predetermined travel is performed.

When the predetermined travel period control routine is executed, first, the HV ECU 70 receives the accelerator depression amount Acc and the rotation speed Nm2 of the second motor MG2 (step S100). It is assumed here that a value detected by the accelerator pedal position sensor 84 is input as the accelerator depression amount Acc. Further, it is assumed that a value calculated on the basis of the rotation position θm2 of the rotor of the second motor MG2, detected by the rotation position detection sensor 44, is input from the motor ECU 40 through communication as the rotation speed Nm2 of the second motor MG2.

Having received these data, the HV ECU 70 sets the target rotation speed Ne* of the engine 22 in accordance with Equation (1), shown below, using the rotation speed Nm2 of the second motor MG2 and a predetermined rotation speed Nm1 set of the first motor MG1, and transmits the set target rotation speed Ne* to the engine ECU 24 so that the first motor MG1 rotates at the predetermined rotation speed Nm1 set (step S110). The HV ECU 70 then sets the target voltage VH* of the drive voltage system power line 54a in accordance with the accelerator depression amount Acc, and transmits the set target voltage VH* to the motor ECU 40 (step S120), whereupon the routine is terminated. The engine ECU 24, having received the target rotation speed Ne* of the engine 22, performs intake air amount control, fuel injection control, ignition control, and the like on the engine 22 so that the engine 22 rotates at the target rotation speed Ne*. Further, the motor ECU 40, having received the target voltage VH* of the drive voltage system power line 54a, performs switching control on the transistors T31, T32 of the boost converter 55 so that the voltage VH of the drive voltage system power line 54a reaches the target voltage VH*.

Ne*=Nm1set×ρ/(1+ρ)+Nm2/(1+ρ) (1)

FIG. 4 is an illustrative view illustrating an example of a collinear diagram showing a relationship between rotation speeds of rotational elements of the planetary gear set 30 during the predetermined travel period. On the diagram, a left side S axis indicates a rotation speed of the sun gear, which corresponds to the rotation speed Nm1 of the first motor MG1, a C axis indicates a rotation speed of the carrier, which corresponds to the rotation speed Ne of the engine 22, and an R axis indicates a rotation speed of the ring gear (the drive shaft 36), which corresponds to the rotation speed Nm2 of the second motor MG2. Also on the diagram, a thickly drawn arrow on the S axis indicates torque (referred to hereafter as counter-electromotive torque) Tce output from the first motor MG1 when a counter-electromotive voltage Vce generated as the first motor MG1 rotates is higher than the voltage VH of the drive voltage system power line 54a. A thickly drawn arrow on the R axis indicates torque acting on the drive shaft 36 via the planetary gear set 30 in accordance with the counter-electromotive torque Tce. Using this collinear diagram, Equation (1) can be derived easily.

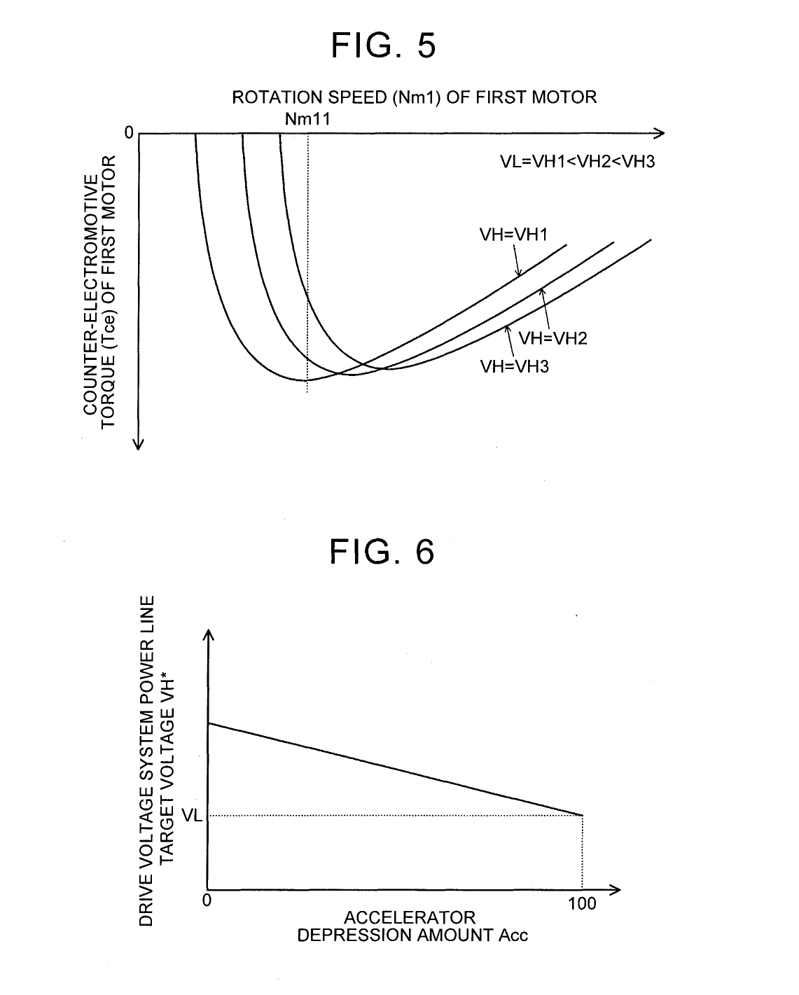

Next, the predetermined rotation speed Nm1 set of the first motor MG1 will be described. FIG. 5 is an illustrative view illustrating an example of a relationship between the rotation speed Nm1 of the first motor MG1, the voltage VH of the drive voltage system power line 54a, and the counter-electromotive torque Tce of the first motor MG1 when the gate of the first inverter 41 is blocked. As shown in the drawing, the counter-electromotive torque Tce is generated when the rotation speed Nm1 of the first motor MG1 is higher than a lower limit rotation speed Nm1min (VH). Here, the lower limit rotation speed Nm1min (VH) is the rotation speed Nm1 of the first motor MG1 when the counter-electromotive voltage Vce generated as the first motor MG1 rotates is equal to the voltage VH of the drive voltage system power line 54a, and increases as the voltage VH of the drive voltage system power line 54a increases. Further, the counter-electromotive torque Tce increases in a region where the rotation speed Nm1 of the first motor MG1 is higher than the lower limit rotation speed Nm1min (VH), and therefore the counter-electromotive torque Tce decreases comparatively rapidly from a value of zero until it reaches a minimum value Tcep (VH) (a maximum value when expressed as an absolute value), and then increases gently. Moreover, a minimum value rotation speed Nm1p (VH), which is the rotation speed Nm1 of the first motor MG1 when the counter-electromotive torque Tce reaches the minimum value Tcep (VH), increases steadily as the voltage VH of the drive voltage system power line 54a increases. In addition, the minimum value Tcep (VH) of the counter-electromotive torque Tce increases steadily (the absolute value thereof decreases steadily) as the voltage VH of the drive voltage system power line 54a increases.

In this embodiment, in consideration of the relationship shown in FIG. 5, the rotation speed Nm1 (a rotation speed Nm11 in FIG. 5, for example 4000 rpm, 5000 rpm, 6000 rpm, or the like) of the first motor MG1 at which the counter-electromotive torque Tce reaches a minimum value Tcep (VH1) when the voltage VH of the drive voltage system power line 54a is at a voltage VH1, which is equal to the voltage VL of the battery voltage system power line 54b, is used as the predetermined rotation speed Nm1set. Hence, in contrast to a case where a lower rotation speed than the rotation speed Nm11 is used as the predetermined rotation speed Nm11, the counter-electromotive torque Tce of the first motor MG1 can be prevented from varying greatly when rotation variation occurs in the first motor MG1 in response to rotation variation in the engine 22. Further, in contrast to a case where a higher rotation speed than the rotation speed Nm11 is used as the predetermined rotation speed Nm1 set, the counter-electromotive torque Tce of the first motor MG1 can be reduced (the absolute value thereof can be increased) by adjusting the voltage VH of the drive voltage system power line 54a. Therefore, as is evident from the collinear diagram in FIG. 4, the rotation speed Ne of the engine 22 can be prevented from racing. Accordingly, rotation variation in the first motor MG1 caused by rotation variation in the engine 22 can be suppressed, and as a result, variation in the counter-electromotive torque Tce of the first motor MG1 can be suppressed when the accelerator depression amount Acc is substantially constant or the like.

Next, the target voltage VH* of the drive voltage system power line 54a will be described. In this embodiment, the target voltage VH* of the drive voltage system power line 54a is set by determining a relationship between the accelerator depression amount Acc and the target voltage VH* of the drive voltage system power line 54a in advance, storing the determined relationship in a ROM, not shown in the drawings, in the form of a target voltage setting map, and when the accelerator depression amount Acc is provided, deriving the corresponding target voltage VH* of the drive voltage system power line 54a from the stored map. FIG. 6 shows an example of the target voltage setting map. As shown in the drawing, the target voltage VH* of the drive voltage system power line 54a is set on an incline so as to increase steadily from the voltage VL of the battery voltage system power line 54b when the accelerator depression amount Acc is 100% as the accelerator depression amount Acc decreases from 100%. As is evident from FIG. 5, the reason for this is that when the rotation speed Nm11 is used as the predetermined rotation speed Nm1set of the first motor MG1, the counter-electromotive torque Tce of the first motor MG1 increases (the absolute value thereof decreases) steadily as the voltage VH of the drive voltage system power line 54a increases. By setting the target voltage VH* of the drive voltage system power line 54a in this manner and then controlling the boost converter 55, the absolute value of the counter-electromotive torque Tce of the first motor MG1 can be increased steadily as the accelerator depression amount Acc increases, and as a result, the torque output to the drive shaft 36 can be increased.

By controlling the rotation speed Nm1 of the first motor MG1 using the engine 22 and controlling the voltage VH of the drive voltage system power line 54a using the boost converter 55 in this manner, the counter-electromotive torque Tce of the first motor MG1 can be adjusted more appropriately than when the engine 22 is controlled alone, and as a result, an improvement in controllability can be achieved during travel performed while the respective gates of the first inverter 41 and the second inverter 42 are both blocked.

In the hybrid automobile 20 according to this embodiment, described above, during the predetermined travel period in which the engine 22 is operative and the respective gates of the first inverter 41 and the second inverter 42 are both blocked, the engine 22 is controlled such that the first motor MG1 rotates at the predetermined rotation speed Nm1set, and the boost converter 55 is controlled such that the voltage VH of the drive voltage system power line 54a reaches the target voltage VH* corresponding to the accelerator depression amount Acc. In so doing, the counter-electromotive torque Tce of the first motor MG1 can be adjusted more appropriately than when the engine 22 is controlled alone, and as a result, an improvement in controllability can be achieved during travel performed while the respective gates of the first inverter 41 and the second inverter 42 are both blocked.

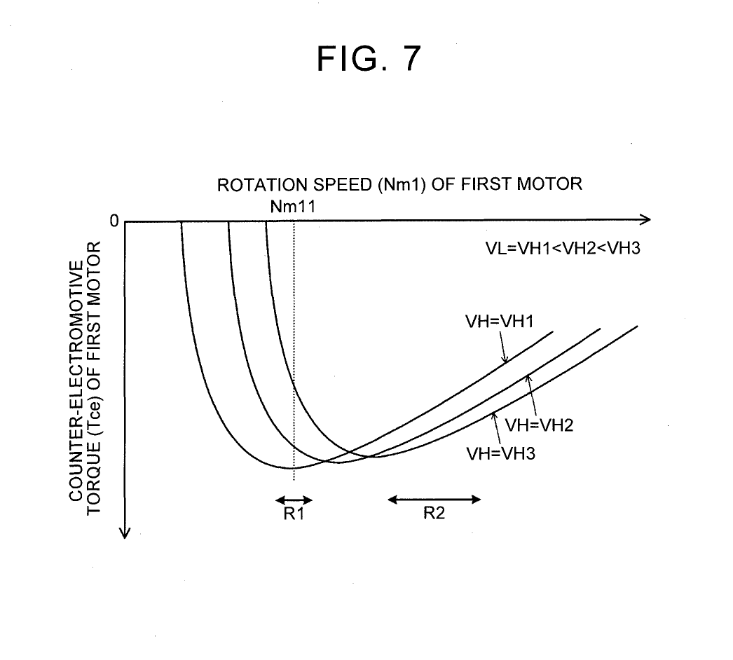

Next, a modified example obtained by slightly modifying this embodiment will be described. In the hybrid automobile 20 according to this embodiment, the rotation speed Nm11 described above is used as the predetermined rotation speed Nm1set of the first motor MG1 during the predetermined travel period, but as a modified example, a slightly lower rotation speed or a slightly higher rotation speed than the rotation speed Nm 11 may be used as the predetermined rotation speed Nm1set of the first motor MG1. In this case, as shown in FIG. 7, a rotation speed within a first rotation speed range (a rotation speed range including the rotation speed Nm11) R1 that inclines such that the counter-electromotive torque Tce of the first motor MG1 increases (the absolute value thereof decreases) steadily as the voltage. VH of the drive voltage system power line 54a increases, or a rotation speed within a second rotation speed range R2 that inclines such that the counter-electromotive torque Tce of the first motor MG1 decreases (the absolute value thereof increases) steadily as the voltage VH of the drive voltage system power line 54a increases, is preferably used as the predetermined rotation speed Nm1set. Note that when a rotation speed within the second rotation speed range R2 is used as the predetermined rotation speed Nm1set, the boost converter 55 may be controlled by setting the target voltage VH* of the drive voltage system power line 54a on an incline so as to increase steadily as the accelerator depression amount Acc increases.

Note that the description provided in the (DETAILED DESCRIPTION OF EMBODIMENTS) is merely a specific example used to illustrate the invention, and respective constituent elements of the invention are not limited thereto. In other words, the invention described in the (SUMMARY OF THE INVENTION) is to be interpreted on the basis of the description in that section, while the embodiment is merely a specific example of the invention described in the (SUMMARY OF THE INVENTION).

An embodiment of the invention was described above, but the invention is not limited in any way to this embodiment and may of course be implemented in various embodiments within a scope that does not depart from the spirit of the invention. The invention may be used in the hybrid automobile manufacturing industry and so on.

1. A hybrid automobile comprising:
an engine;
a first motor configured to receive and output power;
a planetary gear set connected to a rotational shaft of the first motor, an output shaft of the engine, and a drive shaft coupled to an axle such that when respective rotation speeds of the rotational shaft, the output shaft, and the drive shaft, are shown on a collinear diagram, the rotational shaft, the output shaft, and the drive shaft are arranged in that order;
a second motor configured to receive and output power from and to the drive shaft;
a first inverter configured to drive the first motor;
a second inverter configured to drive the second motor;
a battery;
a boost converter connected to a drive voltage system power line, to which the first motor and the second motor are connected, and a battery voltage system power line, to which the battery is connected, the boost converter being configured to adjust a voltage of the drive voltage system power line within a range equaling or exceeding a voltage of the battery voltage system power line; and
a controller configured to:
(i) control the engine and the boost converter, during a predetermined travel period in which the engine is operative and respective gates of the first inverter and the second inverter are blocked, such that travel is performed using a counter-electromotive torque generated when the first motor rotates at a rotation speed corresponding to the rotation speed of the drive shaft and a rotation speed of the engine; and
(ii) control the engine such that the first motor rotates at a predetermined rotation speed and control the boost converter such that the voltage of the drive voltage system power line reaches a target voltage corresponding to an accelerator operation amount during the predetermined travel period.

2. The hybrid automobile according to claim 1, wherein the predetermined rotation speed is a rotation speed within a rotation speed range in which an absolute value of the counter-electromotive torque increases steadily as the voltage of the drive voltage system power line decreases, and the controller is configured to set the target voltage of the drive voltage system power line to decrease steadily as the accelerator operation amount increases during the predetermined travel period.

3. The hybrid automobile according to claim 1, wherein the predetermined rotation speed is a rotation speed at which an absolute value of the counter-electromotive torque reaches a maximum when the gate of the first inverter is blocked and the voltage of the drive voltage system power line is equal to the voltage of the battery voltage system power line.

4. The hybrid automobile according to claim 1, wherein the predetermined rotation speed is a rotation speed within a first rotation speed range in which an absolute value of the counter-electromotive torque decreases steadily as the voltage of the drive voltage system power line increases.

5. The hybrid automobile according to claim 1, wherein the predetermined rotation speed is a rotation speed within a second rotation speed range in which an absolute value of the counter-electromotive torque increases steadily as the voltage of the drive voltage system power line increases.

6. The hybrid automobile according to claim 5, wherein, when a rotation speed within the second rotation speed range is used as the predetermined rotation speed, the controller is configured to set the target voltage of the drive voltage system power line so as to increase steadily as the accelerator operation amount increases.
